(19) United States
(12) Patent Application Publication
(10) Pub. No.: US 2022/0008284 A1
(43) Pub. Date: Jan. 13, 2022

(54) SELF-MASSAGE DEVICE HAVING INTERCHANGEABLE MASSAGE HEADS AND BOARD

(71) Applicants: William Smith, Vero Beach, FL (US); Cameron Smith, Steamboat Springs, CO (US); Dominic Rainville, Sainte-Julie (CA)

(72) Inventors: William Smith, Vero Beach, FL (US); Cameron Smith, Steamboat Springs, CO (US); Dominic Rainville, Sainte-Julie (CA)

(21) Appl. No.: 17/180,654

(22) Filed: Feb. 19, 2021

Related U.S. Application Data
(60) Provisional application No. 63/051,164, filed on Jul. 13, 2020.
(60) Provisional application No. 63/116,655, filed on Nov. 20, 2020.
(60) Provisional application No. 63/128,636, filed on Dec. 21, 2020.

(51) Int. Cl. A61H 23/02

(52) U.S. Cl. CPC A61H 23/02; A61H 2201/5012; A61H 2201/1685; A61H 2201/0119

(57) ABSTRACT

Described is a self-massage device including a massage board with multiple connected indentations formed along the length of the massage board. The self-massage device also includes one or more massage heads having a top portion formed to contact a portion of a user's body, and a bottom portion having a protrusion formed to be removably inserted into one or more of the connected indentations in the massage board via a pressure mechanism.

### CROSS-REFERENCE TO RELATED APPLICATIONS

This is a Non-Provisional Application of U.S. Provisional Application No. 63/051,164, filed in the United States on Jul. 13, 2020, entitled, “Pso Much Better,” the entirety of which is incorporated herein by reference. This is also a Non-Provisional Application of U.S. Provisional Application No. 63/116,655, filed in the United States on Nov. 20, 2020, entitled, “Roman Arch Therapeutic Device,” the entirety of which is incorporated herein by reference. This is also a Non-Provisional Application of U.S. Provisional Application No. 63/128,636, filed in the United States on Dec. 21, 2020, entitled, “Electrical Platform for Receiving Removable Therapeutic Heads,” the entirety of which is incorporated herein by reference.

### BACKGROUND OF INVENTION

### (1) Field of Invention

The present invention relates to a self-massage device and, more particularly, to a self-massage device having a massage board with interchangeable massage heads.

### (2) Description of Related Art

The following art defines the present state of this field:

Mollohan, U.S. Pat. No. D823,479, is the design for the PSO-RITE® massage tool. The massage tool is formed of one piece, having two vertical heads, and is not adjustable to allow for different body sizes.

PSO-SPINE™ is a product similar to the PSO-RITE® massage tool, which is intended to relieve tight muscles adjacent to the spine. The PSO-SPINE™ tool is formed of one piece, having a series of vertical-only heads that are not adjustable or interchangeable.

The PSOAS Release Tool is a massage tool designed with wheels to allow adjustment of body positioning during use. The PSOAS Release Tool is sold by a company by the same name located at 1605 W 2100 S. Salt Lake City, Utah 84119. While the PSOAS Release Tool allows adjusting of the user's body while using the tool, it is not adjustable in length to allow for different body sizes and does not include interchangeable massage heads for different types of massage.

Karvandi, U.S. Pat. No. D905,180 is the design for the HIP HERO Psoas Massager. The HIP HERO heads are adjustable via a very limited sliding mechanism; however, the heads are not removable or interchangeable for different types of massage.

Howard, U.S. Pat. No. 6,315,742 describes a massaging device for massage along the spine comprising a hand-held frame with rollers.

Vitko, U.S. Pat. No. 6,390,997 describes a back stimulation device comprising a frame with a headrest, axles, and roller balls.

Emmel, U.S. Publication No. 2006/0247562 describes a manipulation device having a pair of protrusions directed upward and spaced to allow room for a person's spinal column or large muscle groups or joints to be suspended between said protrusions.

Masek, U.S. Publication No. 2009/0012435 describes an adjustable massage tool comprising a base, a first threaded shank engaged with a first threaded fastener, a second threaded shank engaged with a second threaded fastener, a first pressure ball attached to the first threaded shank, and a second pressure ball attached to the second threaded shank, wherein the pressure balls are configured to extend upwards from the base when the base is placed on the ground.

Chongsu LEE, U.S. Publication No. 2020/0297570 describes a back therapy apparatus comprising manipulating elements movably mounted to a frame and controlled by a controller coupled to the manipulating elements.

Burns, et al., U.S. Publication No. 2020/0323733 describes a portable therapeutic device comprising a body with a recessed region and massage balls within the recessed region, and a power source coupled to the massage balls.

The prior art teach massage devices with rollers, balls, and massage heads in various arrangements. However, the prior art does not teach a single massage tool with interchangeable and repositionable massage heads that can target different body parts and different body sizes.

### SUMMARY OF THE INVENTION

The present invention relates to a self-massage device and, more particularly, to a self-massage device having a massage board with interchangeable massage heads. The self-massage device comprises a massage board having a length comprising a plurality of connected indentations formed along the length of the massage board, and at least one massage head comprising a top portion and a bottom portion. The top portion is formed to contact a portion of a user's body, and the bottom portion comprises a protrusion formed to be removably inserted into one or more of the plurality of connected indentations in the massage board via a pressure mechanism.

In another aspect, the top portion of the at least one massage head is curved.

In another aspect, the at least one massage head is repositionable along the massage board via the plurality of connected indentations.

In another aspect, the top portion of the at least one massage head forms an arch having a first end and a second end.

In another aspect, the arch extends perpendicular to and over the massage board when the at least one massage head is inserted into one or more of the plurality of connected indentations, such that the first end is on a first side of the massage board and the second end is on a second side of the massage board that is parallel to the first side.

In another aspect, the massage board comprises a printed circuit board housed within the massage board and configured to provide power to the at least one massage head when inserted within the massage board.

In another aspect, a plurality of electrical contacts are positioned within the plurality of connected indentations.

In another aspect, a plurality of electrical contacts are attached with the bottom portion of the at least one massage head.

In another aspect, the at least one massage head comprises a motor therein.

In another aspect, the motor causes the at least one massage head to vibrate.

In another aspect, the massage board is configured to wirelessly communicate with a mobile application.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is an illustration of a massage board according to embodiments of the present disclosure;

FIG. 2 is an illustration of a front view of a curved massage head according to embodiments of the present disclosure;

FIG. 3 is an illustration of a bottom view of the curved massage head according to embodiments of the present disclosure;

FIG. 4 is an illustration of a pair of curved massage heads inserted into the massage board according to embodiments of the present disclosure;

FIG. 5 is an illustration of a side view of an arched massage head according to embodiments of the present disclosure;

FIG. 6 is an illustration of a bottom view of an arched massage head according to embodiments of the present disclosure;

FIG. 7 is an illustration of a pair of arched massage heads inserted into the massage board according to embodiments of the present disclosure;

FIG. 8 is an illustration of an exploded view of an electrical massage board and powered curved massage heads according to embodiments of the present disclosure;

FIG. 9 is an illustration of a bottom view of a powered curved massage head according to embodiments of the present disclosure; and

FIG. 10 is an illustration of an interior of a curved massage head showing a vibratory motor therein according to embodiments of the present disclosure.

### DETAILED DESCRIPTION

The present invention relates to a self-massage device and, more particularly, to a self-massage device having a massage board with interchangeable massage heads. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter-clockwise have been used for convenience purposes only and are not intended to imply any particular fixed direction. Instead, they are used to reflect relative locations and/or directions between various portions of an object. As such, as the present invention is changed, the above labels may change their orientation.

### (1) Specific Details of Various Embodiments

Described herein is a therapeutic, self-massage device intended to release muscle tension for various abdomen, leg, back and neck muscle groups, including the iliopsoas, gluteus maximus, quadratus lumborum, and piriformis. The present invention allows a user to put variable pressure into specific areas of the body that are often difficult to access. Unlike existing products, the therapeutic device described herein is designed for multiple purposes in a single product.

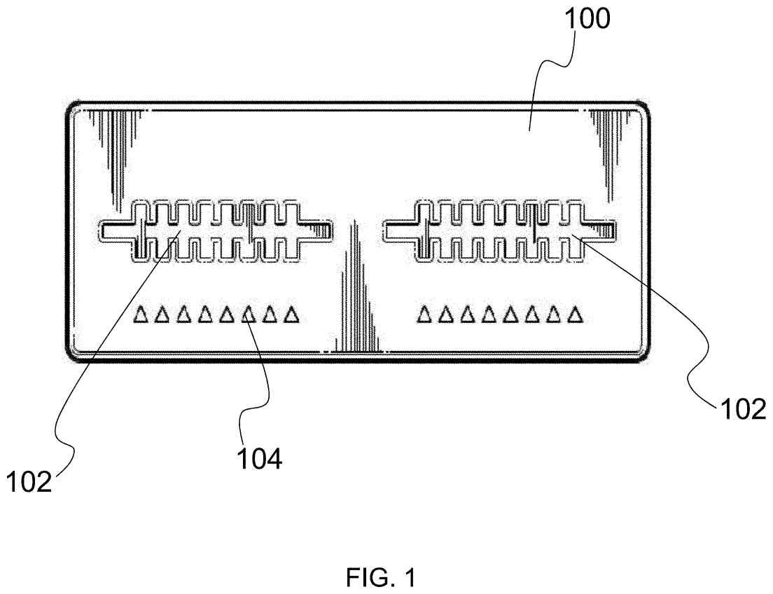

As shown in FIG. 1, the self-massage device comprises a massage board 100 intended to be placed on the floor. The massage board 100 can be formed of a single rectangular planar element or two (or more) planar elements that can be secured together (e.g., snap-fit mechanism, interlocking mechanism). A multi-piece design would allow for easy portability and can be sized to fit within a small travel bag/case. The massage board 100 comprises two separate groupings of slots 102 (or indentations) formed within the surface of the massage board 100. As shown in FIG. 1, each grouping of slots 102 is a continuous, or connected, sequence of parallel indentations with one indentation running perpendicularly across the sequence of parallel indentations, similar to a series of “plus” signs. The slots 102 are formed to receive various types of massage heads and allow for a variety of spacings between a pair of massage heads. Each removable massage head is inserted in an indentation in the grouping of indentations, or slots 102, symmetrically spaced from one another. The massage board 100 further includes position indicators 104 (which can be numbered), which provide visual feedback to the user regarding what position the attachment head is currently in and help the user remember their favorite position for any pair of attachment heads. For example, the position indicators 104 can be numbered so that a user can remember 1-1, 1-2, or 2-2 as the position of the attachment heads in the massage board 100 for a certain release/recovery attempt.

The locking mechanism of each massage head to the massage board 100 is a snap-fit, press-fit, or pressure mechanism. This type of fit is also known as an interference fit. This fit mechanism is a form of fastening between two tight mating parts, in this case the attachment head and the slot 102, that produces a joint which is held together by friction once the parts are pushed together. In the present invention, the fastening/fitting of the two parts is achieved with a reasonable amount of force so that any user can utilize the invention. The attachment between the massage head and the massage board 100 is snug such that the massage head will stay secured to the massage board 100 even if it is turned upside down. A user positions the desired massage head within the desired slot 102 and then presses down on the massage head to lock the massage head into place on the massage board 100. In order to release/remove a massage head, the user then pulls the massage head up and out of the slot 102 with a small amount of force.

(1.1) Curved Massage Head 104

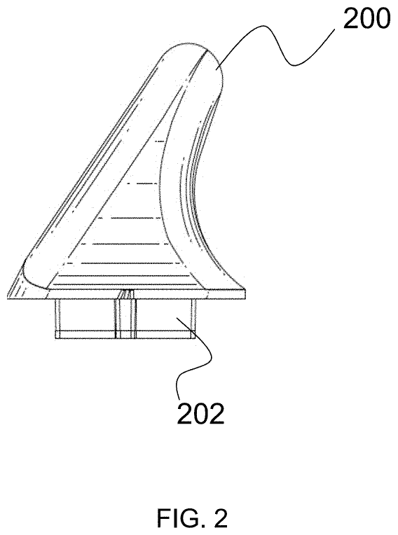

One of the types of massage heads used with the massage board 100 is a curved massage head 200, as depicted in FIG. 2. The curved design at the top portion of the curved massage head 200 and the adjustable positioning of the curved massage heads 200 on the massage board 100 allow a user to access difficult to reach places on the body and apply variable pressure by lowering oneself onto the top portion of the curved massage heads 200, thereby directing pressure to the intended muscle group through the effects of gravity. The ability to reversibly reposition the curved massage heads 200 within the massage board 100 allows for universal use for all users and all muscle sizes. Athletes, in particular, are continually dealing with tight muscle groups. The self-massage device described herein used before or after exercise will allow athletes to increase flexibility and mobility, and prevent injuries. Furthermore, the massage board 100 and massage heads are portable for taking on the go to practices, on travel, or using at home.

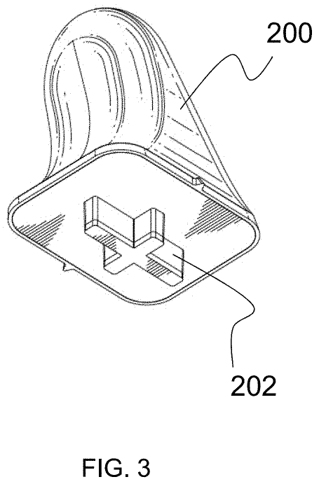

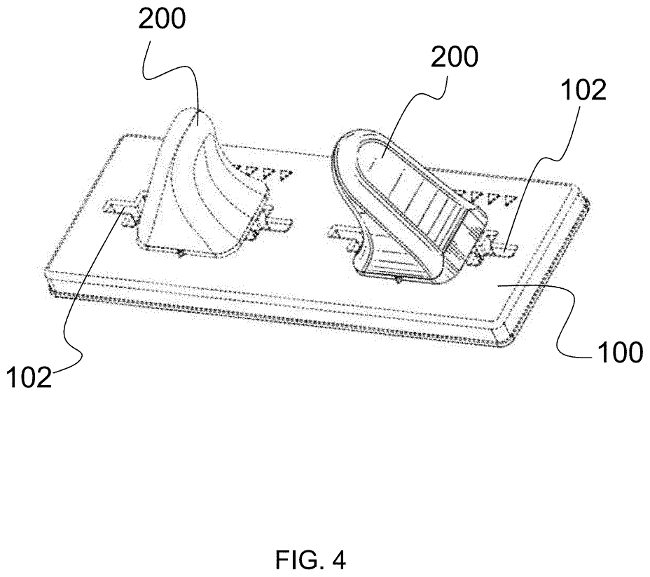

Each interchangeable massage head, including the curved massage head 200, has an extension element, or protrusion 202. In a desired embodiment, the protrusion 202 extends in the shape of a “cross” or “plus” from the bottom of the massage head 200, as shown in FIG. 3. This protrusion 202 is the portion of the curved massage head 200 that is inserted into the massage board 100 to provide a secure coupling. To reposition the curved massage head 200 (and other massage heads), the curved massage head 200 is lifted out of its slot 102 and moved to another slot 102. FIG. 4 illustrates an in use depiction of the self-massage device described herein, showing a pair of curved massage heads 200 inserted within the slots 102 of the massage board 100.

(1.2) Arched Massage Head 500

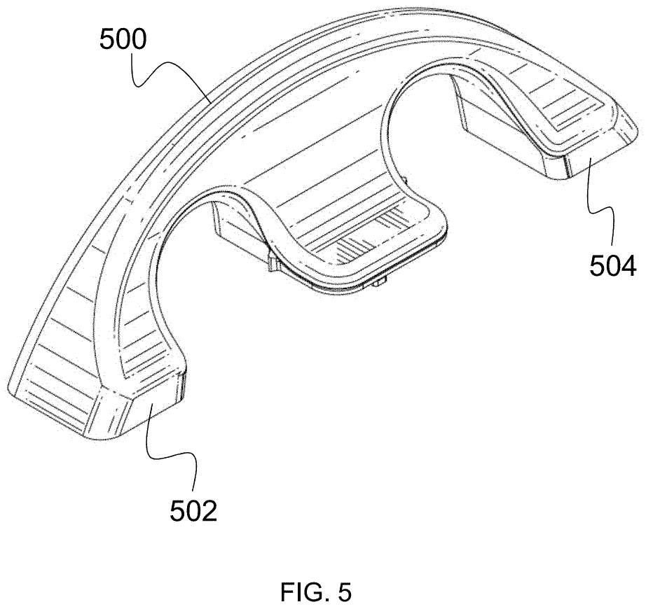

As described above, the massage board 100 is intended to be used with multiple types of removable and re-insertable massage heads in addition to the curved massage heads 200 described above. For instance, another type of massage head to be used with the massage board 100 is an arched massage head 500, as shown in FIG. 5. A pair of arched massage heads 500 combined with the massage board 100 produce a therapeutic device for releasing muscle tension in the numerous overlaying muscles in the sacral curve, lumbar back, thoracic back and cervical neck regions. The arched massage heads 500 also stretch the back and spine, which may result in “back cracking”.

As illustrated in FIG. 5, the arched massage head 500 extends perpendicular to and over the massage board 100 when the arched massage head 500 is inserted into one or more of the slots (indentations) of the massage board 100, such that a first end 502 of the arched massage head 500 is on a first side of the massage board 100 resting on the ground (when in use), and a second end 504 is on a second side of the massage board 100 that is parallel to the first side, also resting on the ground (when in use).

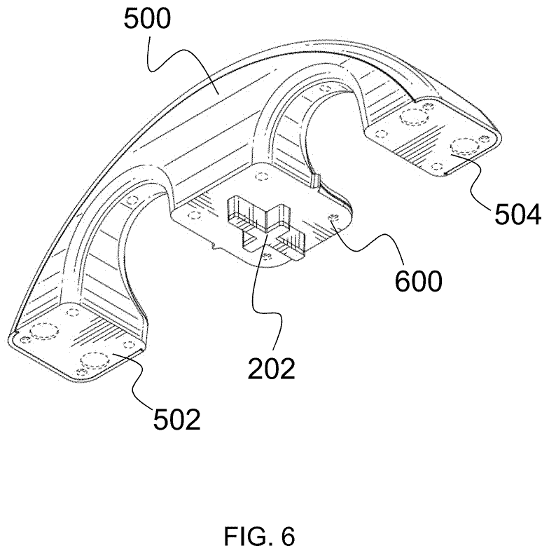

The arched massage heads 500 are intended to be used in conjunction with the massage board 100 in a manner similar to that of the curved massage heads 200. FIG. 6 depicts the protrusion 202 at the bottom of the arched massage head 500. As with the curved massage head 200, the protrusion 202 of the arched massage head 500 will be inserted into the slots 102 of the massage board 100, and the top portion of the arched massage head is the portion that comes into contact with the user's body. As shown in FIG. 6, the protrusion 202 extends from a center attachment portion 600 of the arched massage head that is between the first end 502 and the second end 504.

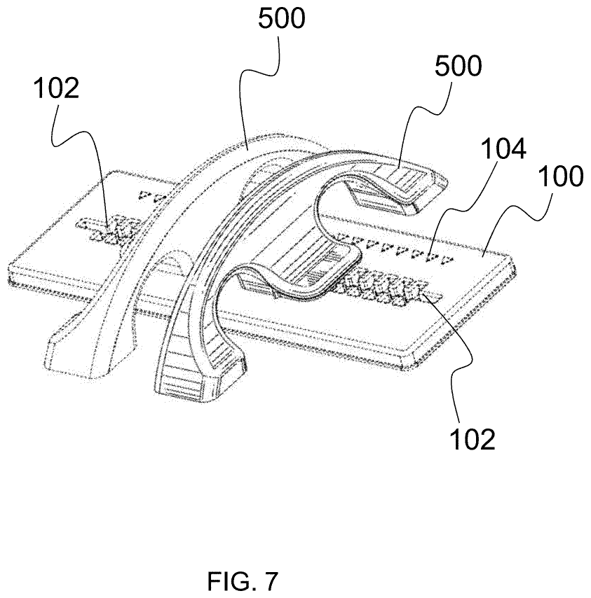

As shown in FIG. 7, with the massage board 100 placed on the floor, two arched massage heads 500 can be inserted symmetrically apart into the two groupings of slots 102 on the massage board 100 (one arched massage head 500 per grouping of slots 102). At the innermost positions of the groupings of slots 102, the arched massage heads 500 will be approximately one inch apart (center-of-arch to center-of-arch), allowing a sitting person to lay back onto the arched massage heads 500, positioning their spine between the arched massage heads 500. By laying back onto the arched massage heads 500, a person will contact erector spinae, rhomboid minor, and major and trapezius muscles (as examples) near the spine and can apply variable pressure to the intended muscle groups through the effects of gravity. A larger person might choose specific positions on the massage board 100 groupings of slots 102 (via position indicators 104) in order to encapsulate their spine more comfortably. Additionally, a person may choose to get muscle relief radiating away from the spine by using different positions for the arched massage heads 500 on the massage board 100 to get a full back release.

Athletes, in particular, are continually dealing with tight muscle groups and the massage board 100 and arched massage heads 500 used before or after exercise allows athletes to increase flexibility, increase mobility and prevent injuries. Each arched massage head 500 has a large curve or arch, which, when positioned on the massage board 100 allows the arched massage heads 500 to fit between the shoulder blades of a user positioned on the arched massage heads 500. The two arched massage heads 500 put the user in an extension position. As the user moves his/her lower body closer to or further away from the massage board 100, different areas of the back are targeted to provide varying degrees of muscular relief and stretch.

In one embodiment, the arched massage head 500 includes a series of wheels, similar to inline skate wheels, along openings in the arched massage head 500 allowing a person to roll up and down the arched massage heads 500 when inserted in the massage board 100. The wheels would mostly be contained within the arched massage head 500 with approximately 25-50% of the wheel protruding outside the arched massage head 500. The wheels would attach within the arched massage head 500 on spindles and would have bearings for easy rolling.

### (1.3) Electrical Massage Board

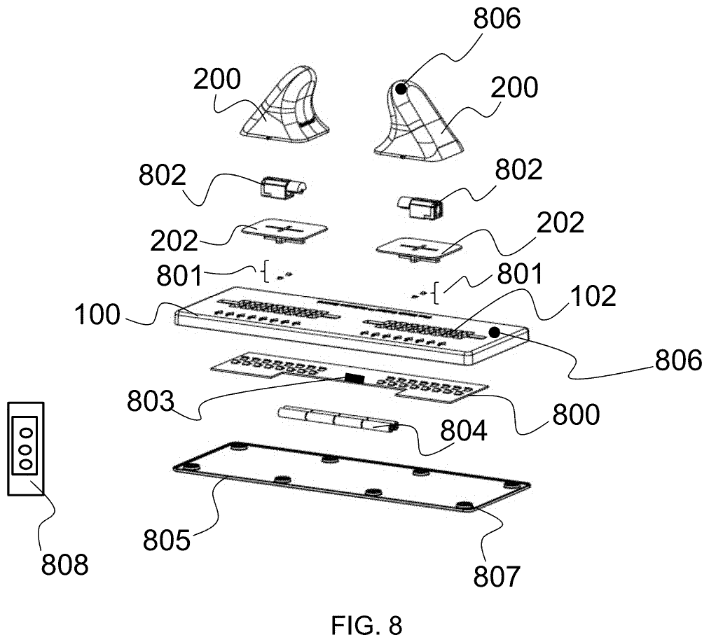

In one embodiment and as shown in exploded view in FIG. 8, the massage board 100 can provide power to the attached massage heads (e.g., curved massage heads 200) in order to elicit a functional response by the curved massage heads 200. In this embodiment, a printed circuit board (PCB) 800 is housed within the massage board 100 and runs the entire length of the slots 102 within the massage board 100. In this embodiment, electrical contacts 801 in the slots 102 are physically attached to the PCB 800. In an alternate embodiment, the electrical contacts 801 are not located on the PCB 800, but are electrically connected to the PCB 800 via wires. The PCB 800 includes a microprocessor 803 capable of communicating with a mobile application, capable of wirelessly communicating with a wireless remote, and having the ability to drive various types of motors 802 in the curved massage heads 200. Electrical. contacts 801 on the massage board 100 and massage heads 200 may not only include electrical contacts 801 but may also be configured to change intensity and type of vibration if the type of motor 802 in the massage head 200 or 500 requires separate connections for those functions. A frame 805 made of, for instance, plastic encloses and secures various parts of the self-massage device (e.g., massage board 100, PCB 800, rechargeable battery 804) via screws. Rubber feet 807 at the bottom of the frame 805 cover the screws and provide a non-slip surface for the invention.

A universal (to all massage heads) rechargeable battery 804 is housed within the massage board 100 and provides power to the PCB 800 inside the massage board 100 and any massage heads (e.g., curved massage heads 200) that are inserted into the massage board 100. When electrical contacts 801 in the slots 102 are engaged, the electrical contacts 801 for all other unenga.ged (i.e., not in contact with a massage head) slots 102 are rendered inoperative by the electronics on the PCB 800 for safety reasons.

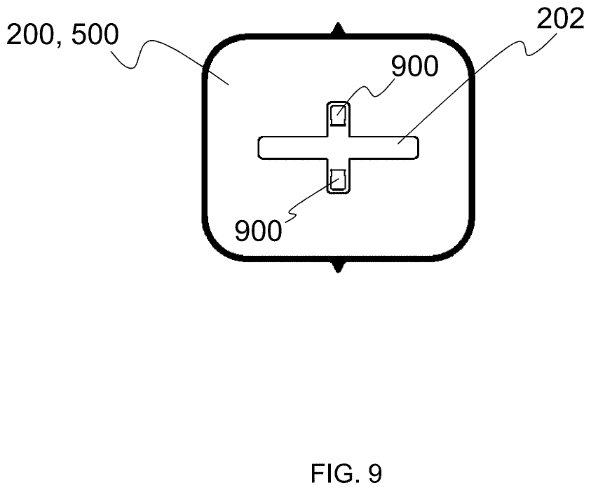

As shown in FIG. 9, in one embodiment, the massage heads (e.g., curved massage head 200) that are configured to connect with the massage board 100 have electrical contacts 900 on either the bottom of the protrusion 202 (e.g., “plus” or “cross” shape), or on one or two of the sides of the protrusion 202. When the massage head (e.g., curved massage head 200) is fully inserted into the slot 102 position, the electrical contacts 900 on the protrusion 202 engage the electrical contacts on the massage board 100 for that slot 102 position.

In another embodiment, the removable massage heads (e.g., curved massage head 200, arched massage head 500) include a vibrating mechanism, such as a motor 802, at the top or bottom of the massage head (e.g., curved massage head 200) that connects with the massage board 100. As shown in FIG. 8, the massage heads (e.g., curved massage head 200) vibrate or deliver percussion therapy with the push of a button/switch 806 on the electrical massage board 100, or, alternatively, via a button/switch 806 on the massage head (e.g., curved massage head 200) itself. Electrical contacts 801 on the massage board 100 provide power to the massage heads 200 or 500 and are located in the slots 102 of the massage board 100. As described above, each slot 102 position in the massage board 100 has its own electrical contacts 801 at either the bottom of the slot 102 or at the sides of the slot 102. The electrical contacts 801 are located in a depression (i.e., the slots 102) on the massage board 100 for both safety and durability.

One or more massage heads 200 or 500 (typically two) are activated by a switch or button 806 on the massage board 100 (or on the massage head) that when placed in the “on” position, provides battery power to the motor 802 inside the massage head (e.g., curved massage head 200). A massage head 200 or 500 can be inserted in either direction and will engage the electrical contacts 801 on the massage board 100. For safety, power cannot be applied for any slot 102 position until a switch or button 806 is activated on the massage board 100, or through a remote switch or button by the user.

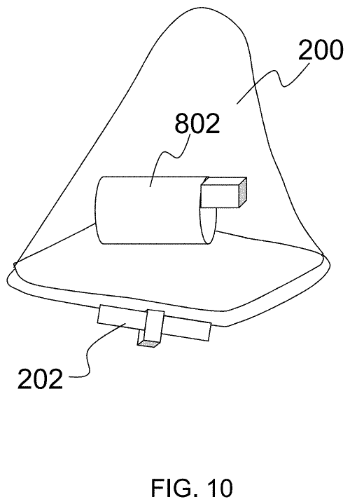

Inside each massage head (e.g., curved massage head 200 as shown in FIG. 8 or arched massage head 500) is a vibrating or percussion therapy motor 802 that provides the action or vibration to the tip of the head when activated. FIG. 10 illustrates the interior of a curved massage head 200, showing one option of a position of the motor 802 within the curved massage head 200. The position of the motor 802 can be different from that shown in FIG. 10 provided that it fulfills the same function of causing a vibratory action of the massage head. As can be appreciated by one skilled in the art, this same configuration of motor positioning is used in the arched massage head 500.

In one embodiment, the PCB 800 inside the massage board 100 comprises a connector (e.g., wire, cord) that penetrates to the exterior of the massage board 100. A user can then connect a remote switch (or button having an electrical cord) that allows the user to engage the self-massage device from awkward positions in which it would be difficult for the user to reach the manual switch. In an alternate embodiment, a wireless remote 808 is provided that can activate the massage heads 200 or 500 by a push of a button on the remote 808. The wireless remote 808 sends a signal to the PCB 800 on the massage board 100 that activates the system.

The wired or wireless remote 808 can also change the vibration volume setting to apply less or more vibration to the tip/edge of the curved massage head 200. The curved massage head 200 can be one piece of injection molded plastic or, in an alternate embodiment, two pieces of injection molded plastic such that the tip (upper portion) of the curved massage head 200 (which can be made out of a different material than the rest of the head, such as an elastomeric material) can flex and move somewhat independently from the larger base (lower portion) of the curved massage head 200. When not in use, the wireless remote 800 can be inserted into an opening on the massage board 100 such that it is flush and completely encapsulated inside the massage board 100 for easy storage of the massage board 100 as well as to make the invention easily portable. In an another embodiment, a wired remote 808 is permanently attached to the massage board 100 through a retractable wire which can be pulled away from the massage board 100 or when pulled on slightly, retracts completely into the massage board 100.

In addition to controlling a vibratory mechanism of each massage head 200 or 500, the massage board 100 can also be configured to be able to control heating elements within the massage heads 200 or 500. As can be appreciated by one skilled in the art, the heating elements can be wire wound, etched foil, or any suitable mechanism for implementing heat in the massage head 200 or 500.

The present invention further comprises a mobile application (app) that can communicate with the electrical massage board 100 via wireless communication technology, such as Bluetooth®. The app can upgrade software on the massage board's 100 electronics via wireless communication technology. The app will allow a user to be able to select a specific massaging routine through the app on their mobile device (e.g., smartphone, tablet) that would then be implemented through the massage board 100 via electronics to motors 802 in the massage heads 200 or 500. Non-limiting examples of adjustments made to the massage heads 200 or 500 via the routines include adjustments to parameters, such as duration, intensity of vibration or therapy, and type of vibration, which is dependent on muscle group being massaged.

Vignettes for massaging different muscle groups using specific types of massage heads 200 or 500 on the app would include an on-screen code that the user could type in or choose that would electronically travel through the app to the massage board 100 and then be implemented by the microprocessor 803 within the massage board 100. The massage board 100 electronics would be intelligent enough to identify the type of massage head 200 or 500 installed into the massage board 100 and in what slot 102 it was installed. If a massage routine is selected through the app and the incorrect massage head is installed, the app will generate and display a visual alert (pop up graphic) to the user through the app. An auditory alert (e.g., tone, beep) can also be generated to alert the user.

Additionally, the app is capable of operating in a manual manner identical to the wireless remote 808 capable of turning the massage heads 200 or 500 on, changing the type of vibration and adjusting the intensity. The app can also be used to adjust the temperature of a massage head 200 or 500 (i.e., turn on heat feature) if a heating element is included within the massage head 200 or 500, Furthermore, the app on the mobile device can be upgraded using the ability of the mobile device to connect through the internet to a mobile device app store and/or a website.

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

What is claimed is:

1. A self-massage device, comprising:
a massage board having a length comprising a plurality of connected indentations formed along the length of the massage board; and
at least one massage head comprising a top portion and a bottom portion, wherein the top portion is formed to contact a portion of a user's body, and
wherein the bottom portion comprises a protrusion formed to be removably inserted into one or more of the plurality of indentations in the massage board via a pressure mechanism.

2. The self-massage device as set forth in claim 1, wherein the top portion of the at least one massage head is curved.

3. The self-massage device as set forth in claim 1, wherein the at least one massage head is repositionable along the massage board via the plurality of connected indentations.

4. The self-massage device as set forth in claim 1, wherein the top portion of the at least one massage head forms an arch having a first end and a second end.

5. The self-massage device as set forth in claim 4, wherein the arch extends perpendicular to and over the massage board when the at least one massage head is inserted into one or more of the plurality of connected indentations, such that the first end is on a first side of the massage board and the second end is on a second side of the massage board that is parallel to the first side.

6. The self-massage device as set forth in claim 1, wherein the massage board comprises a printed circuit board housed within the massage board and configured to provide power to the at least one massage head when inserted within the massage board.

7. The self-massage device as set forth in claim 6, wherein a plurality of electrical contacts are positioned within the plurality of connected indentations.

8. The self-massage device as set forth in claim 6, wherein a plurality of electrical contacts are attached with the bottom portion of the at least one massage head.

9. The self-massage device as set forth in claim 6, wherein the at least one massage head comprises a motor therein.

10. The self-massage device as set forth in claim 9, wherein the motor causes the at least one massage head to vibrate.

11. The self-massage device as set forth in claim 6, wherein the massage board is configured to wirelessly communicate with a mobile application.
